(19) United States
(12) Patent Application Publication
(10) Pub. No.: US 2019/0221176 A1
(43) Pub. Date: Jul. 18, 2019

(54) PASSIVE RGBW PANEL FOR MULTI-LAYER DISPLAY

(71) Applicant: PURE DEPTH, INC., Redwood City, CA (US)

(72) Inventor: James S. EMSLIE, Auckland (NZ)

(21) Appl. No.: 16/248,280

(22) Filed: Jan. 15, 2019

Related U.S. Application Data
(60) Provisional application No. 62/617,779, filed on Jan. 16, 2018.

(51) Int. Cl. G09G 3/36; G09G 3/34; G06F 3/041; G02F 1/1347; G02F 1/1335; G02F 1/1343

(52) U.S. Cl. CPC G09G 3/3607; G09G 3/3685; G09G 3/3413; G06F 3/041; G02F 1/1347; G02F 1/13338; G02F 1/134363; G09G 2300/023; G09G 2300/0478; G02F 2201/52; G02F 1/133528

(57) ABSTRACT

A multi-layer display system may include a plurality of display panels arranged in an overlapping manner, a backlight configured to provide light to the plurality of display panels, and a processing system. Each of the display panels includes an array of pixels, each pixel including active red (R), active green (G), and active blue (B) sub-pixels. The pixels in one or more display panels may further include passive white (W) sub-pixels. The multi-layer display may further comprise a pair of crossed polarized layers. The processing system may be configured to control simultaneous display of different content on the plurality of display panels.

### CROSS-REFERENCE TO RELATED APPLICATIONS

This patent application claims priority to and the benefit of U.S. Provisional Application No. 62/617,779, filed on Jan. 16, 2018, which is hereby incorporated by reference in its entirety.

### FIELD OF THE INVENTION

The invention relates generally to multi-layer displays and, more particularly, to multi-layer displays including one or more panels with passive liquid crystal cells.

### BACKGROUND

Image displays limited to a single two dimensional display lack depth information. To relay depth information of displayed content (e.g., text, images, graphics) there have been efforts to provide displays that can display the content in three-dimensions. For example, stereo displays convey depth information by displaying offset images that are displayed separately to the left and right eye. However, stereo displays are limited from what angle the images can be viewed.

Multi-layer displays have been developed to display content with a realistic perception of depth due to displacement of stacked displays screens. However, overlapping display panels and other layers (e.g., filters and polarizers) in the multi-layer displays reduce the brightness of the multi-layer display. To overcome the reduced transmissivity of light in the multi-layer display, a backlight of the multi-layer display is controlled to provide brighter light compared to a traditional display. A disadvantage of doing this is that the increase causes an increase in the power consumed by the multi-layer display.

### SUMMARY

Exemplary embodiments of this disclosure provide a display system that can display content on different display screens of a multi-layer display provided in a stacked arrangement. The multi-layer display may include a plurality of display panels arranged in an overlapping manner, a backlight configured to provide light to the plurality of display screens, and a processing system. Each of the display panels includes an array of pixels, each pixel including active red (R), active green (G), and active blue (B) sub-pixels. The pixels in one or more display panels may further include passive white (W) sub-pixels. The multi-layer display may further comprise a pair of crossed polarized layers. The processing system may be configured to control the display of different content on the plurality of display panels.

According to one exemplary embodiment, an instrument panel comprises a multi-layer display including a front display panel and a rear display panel arranged in a substantially parallel manner, the front display panel overlapping the rear display panel, the front display panel and the rear display panel including an array of pixels, each pixel including active red (R), active green (G), and active blue (B) sub-pixels, the pixels in the front display panel and/or the rear display panel including a plurality of passive white (W) sub-pixels; the multi-layer display further comprising a pair of crossed polarized layers, a first polarized layer of the pair of crossed polarized layers provided in front of and adjacent to the front display panel and a second polarized layer of the pair of crossed polarized layers provided behind and adjacent to the rear display panel; a backlight configured to provide light to the front display panel and the rear display panel of the multi-layer display; and a processing system comprising at least one processor and memory, the processing system configured to: control the front display panel to display a first content; and control the rear display panel to display a second content.

In another exemplary embodiment, the front display panel and the rear display panel are multi-domain in-plane-switching liquid crystal displays.

In another exemplary embodiment, the front display panel and the rear display panel are triple-domain in-plane-switching liquid crystal displays.

In another exemplary embodiment, the instrument panel further comprises a first data driver configured to control the active red (R), active green (G), and active blue (B) sub-pixels of the front display panel and a first gate driver configured to provide scan pulses to the active red (R), active green (G), and active blue (B) sub-pixels of the front display panel; a second data driver configured to control the active red (R), active green (G), and active blue (B) sub-pixels of the front display panel and a second gate driver configured to provide scan pulses to the active red (R), active green (G), and active blue (B) sub-pixels of the front display panel; and a backlight controller configured to control the backlight based on the content simultaneously displayed on the front display panel and the rear display panel.

In another exemplary embodiment, the passive white (W) sub-pixels in the front display panel and/or the rear display panel are not coupled to the first and second data drivers and the first and second gate drivers.

In another exemplary embodiment, the liquid crystal molecules in the passive white (W) sub-pixels are pre-aligned by rubbing or photoalignment.

In another exemplary embodiment, liquid crystal molecules in the passive white (W) sub-pixels have a pre-set uniform orientation in a normal off state of the passive white (W) sub-pixels.

In another exemplary embodiment, liquid crystal molecules in the passive white (W) sub-pixels have a pre-set uniform orientation of 45 degrees relative to the electrodes of the passive white (W) sub-pixels.

In another exemplary embodiment, the front display panel and the rear display panel each include a plurality passive white (W) sub-pixels.

In another exemplary embodiment, only the front display panel includes the plurality passive white (W) sub-pixels.

In another exemplary embodiment, only the rear display panel includes the plurality passive white (W) sub-pixels.

In another exemplary embodiment, the first content is displayed such that at least a portion of the first content overlaps the second content displayed on the rear display panel, and at least a portion of the first content is displayed without overlapping the second content.

In another exemplary embodiment, relative luminance of the first content displayed on the front display panel is higher than relative luminance of the second content displayed on the rear display panel.

In another exemplary embodiment, the front display panel is a touch sensitive display, and the processing system is configured to detect whether a touch input is performed to a portion of the front display displaying the first content.

In another exemplary embodiment, a multi-layer display system, comprising: a first display and a second display arranged in a substantially parallel manner to the first display, the first display overlapping the second display, and the first display and the second display each including a plurality of red (R), green (G), and blue (B) multi-domain liquid crystal display cells, and the first display and/or the second display including a plurality of passive white (W) liquid crystal display cells; a light source configured to provide light to the first display and the second display; a first polarized layer provided in front of and adjacent to the first display; a second polarized layer provided between the light source and the second display; and a processing system comprising at least one processor and memory, the processing system configured to: display a first content on the first display; and display, on the second display, a second content.

In another exemplary embodiment, the red (R), green (G), and blue (B) multi-domain liquid crystal display cells are multi-domain in-plane-switching liquid crystal cells.

In another exemplary embodiment, the red (R), green (G), and blue (B) multi-domain liquid crystal display cells are triple-domain in-plane-switching liquid crystal cells.

In another exemplary embodiment, the first content is displayed such that at least a portion of the first content overlaps the second content displayed on the second display, and at least a portion of the first content is displayed without overlapping the second content.

In another exemplary embodiment, liquid crystal molecules in the passive white (W) liquid crystal display cells are pre-aligned by rubbing or photoalignment.

In another exemplary embodiment, liquid crystal molecules in the passive white (W) sub-pixels have a pre-set uniform orientation in a normal off state of the passive white (W) liquid crystal display cells.

In another exemplary embodiment, liquid crystal molecules in the passive white (W) liquid crystal display cells have a pre-set uniform orientation of 45 degrees relative to the electrodes of the passive white (W) liquid crystal display cells.

In another exemplary embodiment, the first display and the second display each include a plurality passive white (W) liquid crystal display cells.

In another exemplary embodiment, only the second display includes the plurality passive white (W) liquid crystal display cells.

In another exemplary embodiment, an instrument panel comprises; a multi-layer display including a plurality of display panels arranged in a substantially parallel manner, the plurality of display panels including a rear display panel and a front display panel overlapping the rear display panel, at least one of the display panels including active red (R) sub-pixels, active green (G) sub-pixels, active blue (B) sub-pixels, and passive white (W) sub-pixels; the multi-layer display further comprising a pair of crossed polarized layers, a first polarized layer of the pair of crossed polarized layers provided in front of and adjacent to the front display panel and a second polarized layer of the pair of crossed polarized layers provided behind and adjacent to the rear display panel; a backlight configured to provide light to the front display panel and the rear display panel of the multi-layer display; and a processing system comprising at least one processor and memory, the processing system configured to simultaneously display content on the plurality of display panels.

In another exemplary embodiment, at least one of the plurality of display panels is a monochrome panel.

In another exemplary embodiment, the front display panel and the rear display panel are multi-domain in-plane-switching liquid crystal displays.

In another exemplary embodiment, the active red (R) sub-pixels, the active green (G) sub-pixels, the active blue (B) sub-pixels include associated transistors coupled view data lines and the passive white (W) sub-pixels do not include associated transistors.

In another exemplary embodiment, the instrument panel further comprising a pair of crossed polarizers, wherein the plurality of display panels are disposed between the pair of crossed polarizers, and liquid crystal molecules in the passive white (W) sub-pixels are pre-aligned such that during operation regions of the multi-layer display corresponding to the passive white (W) sub-pixels are black.

### BRIEF DESCRIPTION OF THE DRAWINGS

So that features of the present invention can be understood, a number of drawings are described below. It is to be noted, however, that the appended drawings illustrate only particular embodiments of the invention and are therefore not to be considered limiting of its scope, for the invention may encompass other equally effective embodiments.

FIG. 1 illustrates a multi-layer display system according to an embodiment of the present disclosure.

FIG. 2 illustrates top view and perspective view of an in-plane switching mode liquid crystal display device (IPS-LCD) cell in an off state and an on state.

FIG. 3 illustrates a MLD according to an example embodiment of this invention, in which the stacked overlapping layers/displays of any of the figures herein may be provided and utilized.

FIGS. 4A-4C illustrate RGBW wavelength distribution configurations according to various embodiments of this disclosure.

FIG. 5 illustrates an exemplary embodiment of control system for a display including RGBW sub-pixel configuration.

FIG. 6 illustrates an exemplary embodiment of a color filter layer including a planarization layer.

FIG. 7 illustrates an exemplary processing system upon which various embodiments of the present disclosure(s) may be implemented.

### DETAILED DESCRIPTION

Embodiments of this disclosure provide for using a multi-layer display system including a plurality of display panels, with each display panel including a plurality of liquid crystal display cells. Content (e.g., graphics, texts etc.) is displayed on each of the panels simultaneously with at least a portion of the content displayed one panel overlapping content displayed on another panel. As explained in this disclosure, the plurality of display layers in the Multi-layer display (MLD) may cause a reduction in the luminance of the systems and/or require additional power to increase light generated by a backlight. To overcome these challenges, embodiments of this disclosure provide for including passive transparent sub-pixel regions in one or more of the display panels.

MLD systems can use two or more layers of Liquid Crystal TFT's. Normally the TFT layers have pixels including Red, Green, and Blue sub-pixels. The technology can utilize TFT panels with additional transparent sub pixels (RGBW) to increase the transmission of the optical stack and therefore increase brightness or decrease backlight power consumption. There are some trade-offs with using typical RGBW setups in that additional electronics and special algorithms are required to convert display content from the typical RGB scheme.

The problems of transmission in an MLD and the complexity of driving an RGBW in an MLD system are solved by adding a passive RGBW sub-pixel to an MLD display layer. Embodiments of this disclosure propose to deliberately enlarge a third domain of a multi-domain liquid crystal display cell disclosed in U.S. Provisional Application 62/589,608, filed Nov. 22, 2017, and U.S. application Ser. No. 16/195,881, filed Nov. 19, 2018, each of which is incorporated by reference in its entireties herein.

MLD systems using only two polarizers (one on the front of the front LCD layer and one on the Rear of the Rear LCD layer) and having an additive color model, can have RGBW setup so that a gain in transmission is achieved without the need to generate a separate white channel, thereby simplifying the both the driving circuitry from the system on chip (SOC) and the LCD timing controller. The Red, Green, and Blue sub-pixels are controlled per standard methods, however the transparent regions are not addressed and may not have any associated electronics (e.g., no transistors or electrode structures). The liquid crystal is aligned within the transparent sub-pixel regions by rubbing or photoalignment methods such that it would be normally black in the case of a standard single layer LCD with crossed polarizers.

In the two polarizer MLD system, the light transmitting through the two LCD panels is not analyzed until it hits the front polarizer. This means, for example, that light transfers through the transparent regions of the Rear LCD without any color filter attenuation. These polarized rays, depending on the interaction with the subsequent liquid crystal orientations in the front LCD layer and/or other LCD layers between the front and rear LCD layers, can be used to boost the brightness in the red, green, and blue sub-pixels. For example if the red sub-pixel is driven it receives an increase (e.g., a 10% boost) in luminance, likewise for the green and blue sub-pixels. The result is an increase in the possible luminance, and/or a reduction in power consumption, compared to standard RGB configuration.

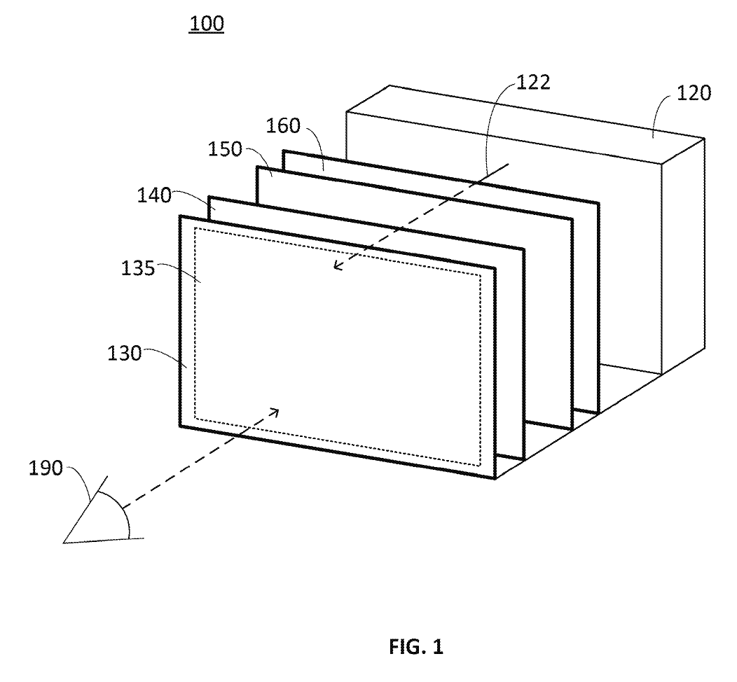

FIG. 1 illustrates a multi-layer display system 100 according to an embodiment of the present disclosure. The display system 100 may include a light source 120 (e.g., rear mounted light source, side mounted light source, optionally with a light guide), and a plurality of display screens 130-160. Each of the display screens 130-160 may include multi-domain liquid crystal display cells and one or more of the display screen may include a plurality of passive transparent sub-pixel regions.

The display screens 130-160 may be disposed substantially parallel or parallel to each other and/or a surface (e.g., light guide) of the light source 120 in an overlapping manner. In one embodiment, the light source 120 and the display screens 130-160 may be disposed in a common housing. The display apparatus 100 may be provided in an instrument panel installed in a dashboard of a vehicle. The instrument panel may be configured to display information to an occupant of the vehicle via one or more displays 130-160 and/or one or more mechanical indicators provided in the instrument panel. One or more of the mechanical indicators may be disposed between the displays 130-160. The displayed information using the displays 130-160 and/or the mechanical indicators may include vehicle speed, engine coolant temperature, oil pressure, fuel level, charge level, and navigation information, but is not so limited. It should be appreciated that the elements illustrated in the figures are not drawn to scale, and thus, may comprise different shapes, sizes, etc. in other embodiments.

The light source 120 may be configured to provide illumination for the display system 100. The light source 120 may provide substantially collimated light 122 that is transmitted through the display screens 130-160.

Optionally, the light source 120 may provide highly collimated light using high brightness LED's that provide for a near point source. The LED point sources may include pre-collimating optics providing a sharply defined and/or evenly illuminated reflection from their emission areas. The light source 120 may include reflective collimated surfaces such as parabolic mirrors and/or parabolic concentrators. In one embodiment, the light source 120 may include refractive surfaces such as convex lenses in front of the point source. However, the LEDs may be edge mounted and direct light through a light guide which in turn directs the light toward the display panels in certain example embodiments. The light source 120 may comprise a plurality of light sources, with each light source providing backlight to a different region of the display screens 130-160. In one embodiment, the light source 120 may be configured to individual provide and control light for each pixels of a panel in front of the light source 120.

Each of the display panels/screens 130-160 may include a liquid crystal display (LCD) matrix. Alternatively, one or more of the display screens 130-160 may include organic light emitting diode (OLED) displays, transparent light emitting diode (TOLED) displays, cathode ray tube (CRT) displays, field emission displays (FEDs), field sequential display or projection displays. In one embodiment, the display panels 130-160 may be combinations of either full color RGB, RGBW or monochrome panels. Accordingly, one or more of the display panels may be RGB panels, one or more of the display panels may be RGBW panels and/or one or more of the display panels may be monochrome panels. As described in more detail below, one or more of the display panels may be a panel with passive white (W) sub-pixels. The display screens 130-160 are not limited to the listed display technologies and may include other display technologies that allows for the projection of light. In one embodiment, the light may be provided by a projection type system including a light source and one or more lenses and/or a transmissive or reflective LCD matrix. The display screens 130-160 may include a multi-layer display unit including multiple stacked or overlapped display layers each configured to render display elements thereon for viewing through the uppermost display layer.

In one embodiment, each of the display screens 130-160 may be approximately the same size and have a planar surface that is parallel or substantially parallel to one another. In another embodiment, one or more of the display screens 130-160 may have a curved surface. In one embodiment, one or more of the display screens 130-160 may be displaced from the other display screens such that a portion of the display screen is not overlapped and/or is not overlapping another display screen.

Each of the display screens 130-160 may be displaced an equal distance from each other in example embodiments. In another embodiment, the display screens 130-160 may be provided at different distances from each other. For example, a second display screen 140 may be displaced from the first display screen 130 a first distance, and a third display screen 150 may be displaced from the second display screen 140 a second distance that is greater than the first distance. The fourth display screen 160 may be displaced from the third display screen 150 a third distance that is equal to the first distance, equal to the second distance, or different from the first and second distances.

The display screens 130-160 may be configured to display graphical information for viewing by the observer 190. The viewer/observer 190 may be, for example, a human operator or passenger of a vehicle, or an electrical and/or mechanical optical reception device (e.g., a still image, a moving-image camera, etc.). Graphical information may include visual display content (e.g., objects and/or texts). In one embodiment, the graphical information may include displaying images or a sequence of images to provide video or animations. In one embodiment, displaying the graphical information may include moving objects and/or text across the screen or changing or providing animations to the objects and/or text. The animations may include changing the color, shape and/or size of the objects or text. In one embodiment, displayed objects and/or text may be moved between the display screens 130-160. The distances between the display screens 130-160 may be set to obtain a desired depth perception between features displayed on the display screens 130-160.

In one embodiment, a position of one or more of the display screens 130-160 may be adjustable by an observer 190 in response to an input. Thus, an observer 190 may be able to adjust the three dimension depth of the displayed objects due to the displacement of the display screens 130-160. A processing system may be configured to adjust the displayed graphics and gradients associated with the graphics in accordance with the adjustment.

Each of the display screens 130-160 may be configured to receive data and display, based on the data, a different image on each of the display screens 130-160 simultaneously. Because the images are separated by a physical separation due to the separation of the display screens 130-160, each image is provided at a different focal plane and depth is perceived by the observer 190 in the displayed images. The images may include graphics in different portions of the respective display screen.

While not illustrated in FIG. 1, the display system 100 may include one or more projection screens, one or more diffraction elements, and/or one or more filters between an observer 190 and the projection screen 160, between any two display screens 130-160, and/or the display screen 130 and the light source 120.

The display system 100 may include a touch sensitive display surface 135 provided in front of or as part of the front display 130. A processing system may be configured to detect whether a touch input is performed to a portion of the front display displaying the one or more objects.

One or more of the display screens 130-160 may be in-plane switching mode liquid crystal display devices (IPS-LCDs). The IPS-LCD may be a crossed polarizer type with a polarizer on one side of the cells being perpendicular to a polarizer on an opposite side of the cells (i.e., transmission directions of the polarizers are placed at right angles). In one embodiment, a pair of crossed polarized layers may be provided with a first polarizer layer provided in front of the display screen 130 and a second polarizer layer provided behind the display screen 160.

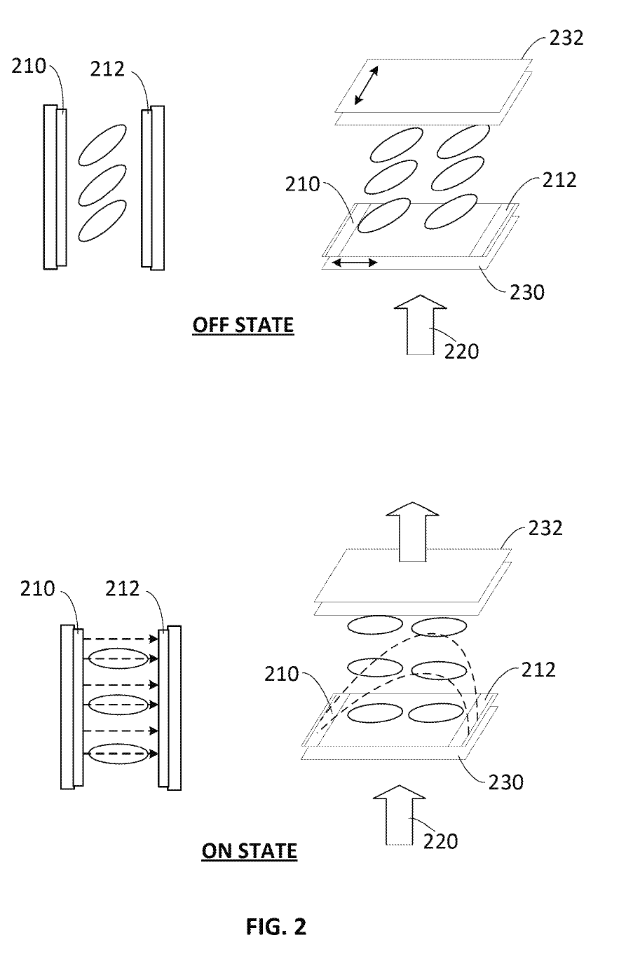

FIG. 2 illustrates top view and perspective view of an IPS-LCD cell in an off state and an on state. In the off state, without a voltage applied to electrodes 210 and 212, liquid crystal molecules in the cell have a uniform orientation at 45 degrees with the electrodes (the LC director is uniform throughout the cell). Polarized light 220 enters and exits the cell without a change in the polarization. The polarized light 220 will be blocked in the off state, if a polarizer 230 on one side of the cell is provided perpendicular to a polarizer 232 on an opposite side of the cell.

In the on state, a voltage is applied to the electrodes 210 and 212. The electric field drives the liquid crystal molecules to rotate in the plane of the substrate and orient along the field direction. The rotation of the molecules causes a phase change to the polarized light 220. The light 220 will be transmitted in the on state.

The transmission T of the light 220, in the on state of an IPS-LCD, can be described by:

$$T = {sin}^{2} ( 2 θ ( V ) ) * {sin}^{2} ( π \frac{Δ nd}{λ} ) ,$$

where θ(V) is the angle between polarizer and the LC director, and is a function of the applied voltage; Δn is the birefringence of cell, d is the cell gap, and λ is the wavelength. Δnd can be chosen so that the value is ˜0.3, hence the second term in the equation can be maximized for visible wavelengths. At V=0, the LC director is parallel to the polarizer, θ=0⁰, hence T=0. At high voltage, most of the molecules align along the electric field, θ=45°, hence T=1.

In one example, the display panels include multi-domain in-plane-switching liquid crystal displays. Displays with multi-domain cells provide an additional deviations from a basic model that is caused by liquid crystal director twist angles varying across the cell. Multi-domain in-plane-switching displays are designed to provide for smaller color shift in an off axis diagonal view, faster response time, wider viewing angle, higher contrast ratio, and/or higher optical efficiently. A multi-domain liquid crystal display cell includes multiple liquid crystal director rotation directions. The multiple rotation directions are provided by different electric fields in each portion of the cell.

The electrode structure may be optimized for peak transmittance, contrast and/or good off angle color. Balance of the three domains, RH twist, LH twist and “no Twist” is significant. The third domain is called “no twist” and model it this way, but it is an approximation to a varying twist over the volume of the cell. The specific electrode structure within the cell provides for the electric field in one portion of the cell to reorient the liquid crystal director in one direction, and the electric field in another portion of the cell to reorient different liquid crystal director in another direction. The electric field causes the liquid crystal directors to be twisted into opposite directions LH and RH to provide the dual-domain liquid crystal configuration.

In one example, the specific electrode structure may include chevron-shaped electrodes. The chevron-shaped electrodes may be alternatively arranged to form inter-digital electrodes on the same substrate as the common electrode and the pixel electrode. In a cell with chevron-shaped electrodes, a liquid crystal material may be disposed between a first substrate and a second substrate to form a liquid crystal cell, and a chevron shaped electrode structure including a plurality of chevron-shaped cell electrodes interleaved with a plurality of chevron-shaped common electrodes in the first substrate, wherein the interleaved plural chevron-shaped cell and common electrodes divide the cell into a plurality of regions. The plurality of regions may include a region where a director is rotated in the left hand direction LH, a region where a director is rotated in right hand direction RH (opposite to the first direction), and a region ZH, which is considered to be an ineffective portion of the cell. For IPS, FIS or FFS type displays in the literature there are only described two domains, left and right hand twist direction. Note that there are portions of the display where there is little or no twist of the LC with applied electric field. For example at the ends of each of the inter-digital electrodes the electric field direction will be parallel with the LC alignment layer so therefore will not be able to induce a twist moment to the LC in the vicinity. In a single layer LCD these inefficient regions contribute to the reduction in transmission efficiency of IPS compared to TN mode LCD. In modeling this it is efficient to lump all of these regions into a third domain models with no twist.

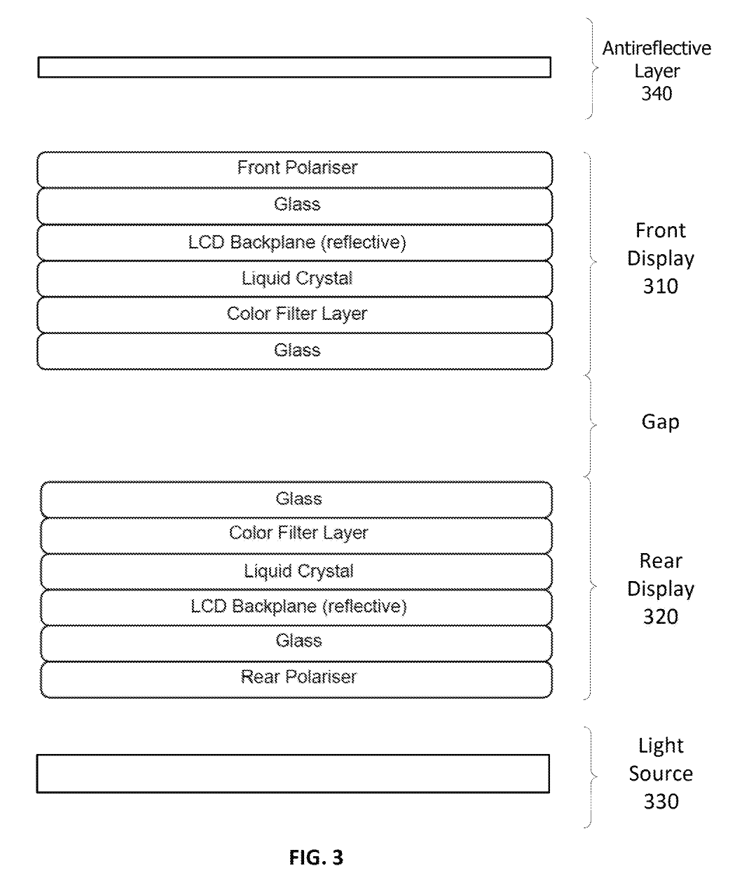

FIG. 3 illustrates a MLD according to an example embodiment of this invention, in which the stacked overlapping layers/displays of any of the figures herein may be provided and utilized. For example, the display screens 130 and 160 (shown in FIG. 1) may correspond the front display 310 and rear display 320 in FIG. 3, respectively.

The front display 310 may be a display that is closest to an observer. The rear display 320 may be a display that is closest to a light source 330 (e.g., backlight) of the MLD. While not illustrated in FIG. 3, one or more other components such as display layer, filters, and/or fillers may be provided in the gap between the front display 310 and the rear display 320.

The MLD includes a crossed polarizer type configuration with a polarizer on one side of the displays being perpendicular to a polarizer on an opposite side of the displays (i.e., transmission directions of the polarizers are placed at right angles). As shown in FIG. 3, a front polarizer is provided on the front of the front display 310 and a rear polarizer is provided on a back surface of the rear display 320. In one embodiment, the MLD may include only two polarizers provided between a plurality of overlapping liquid crystal layers of the displays 310 and 320 and any other liquid crystal layers provided in the gap.

Other polarizers may optionally be provided as part of an antireflective layer 340 (e.g., provided in front of the front display 310) to reduce external reflections of ambient light. The antireflective layer 340 may include a quarter wave retarder and/or an antireflective (AR) polarizer. Additionally, black mask (BM) or other non-reflective material may be added behind the conductive traces of the displays to reduce reflections. Additionally, antireflective (AR) coating(s) may be applied to the interior surfaces in certain example embodiments. The AR coating may, for example, operate in the visible range, e.g., moth eye, single layer interference, multi-layer interference, etc.

Gaps between the displays may be designed to include air or material having birefringence designed to maintain black state of the display when desired. The gap may include material having a refractive index matched closely to glass or the layers on either side to reduce internal reflection and/or depolarization effects. For the front display 310, its backplane may be oriented opposite to that of display 320. In particular, for the front display 310 its backplane may be oriented to face the viewer to reduce internal reflections.

As illustrated in FIG. 3, accordingly to one embodiment, the color filter layers (each of which may be made up of one or more layers) of the respective displays may be designed to face each other, with no liquid crystal layer from either display being located between the color filter layers of the first and second displays in certain example embodiments. The position of the color filter layers is not limited to the illustration in FIG. 3 and may be provided in other positions of the respective display.

The displays may be comprised of pixels arranged in a matrix using an RGB (Red, Green, Blue) wavelength distribution. In this configuration, each pixel is provided only with Red, Green, and Blue colors. A given pixel provides one color image by mixing the red, green and blue light generated from the respective sub-pixels of the pixel. A back light generates light for the pixel, but the RGB pixel transmits only a portion of the light provided by the back light (e.g., 30% of the provided light).

To improve the gain in transmission of the MLD system with the two polarizers (e.g., one on the front of the front LCD layer and one on the rear of the rear LCD layer) one or more of the display layers provided between the front and rear polarizers may include pixels which have an RGBW (Red, Green, Blue and White) wavelength distribution characteristic. This configuration may increase the transmission of the MLD without needing to generate a separate white channel, thereby simplifying both the driving circuitry from the system on chip (SOC) and the LCD timing controller.

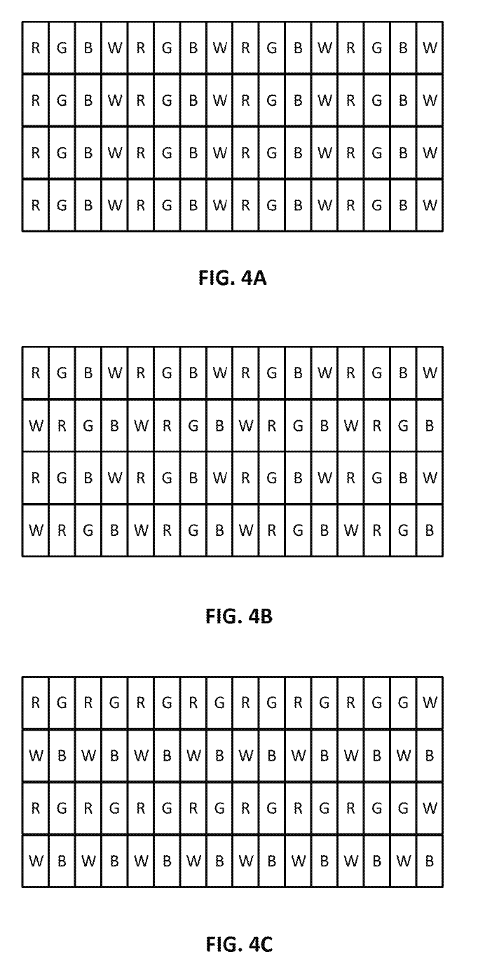

FIGS. 4A-4C illustrate RGBW wavelength distribution configurations according to various embodiments of this disclosure. FIG. 4A illustrates an RGBW pixel configuration including one unit pixel provided with four colors of red (R), green (G), blue (B) and white (W). As shown in FIG. 4A, a rows of white sub-pixels may be formed on the display. In the RGBW configuration, red, green and blue color filters are respectively formed in the red, green and blue sub-pixels. The white sub-pixel may have no color filter. The transmission of the MLD is improved by the additional light provided from the light source via the white sub-pixel. The white sub-pixel passes light (e.g., from the light source and/or other displays) which is mixed with the light passed by the RGB sub-pixels.

FIG. 4B illustrates an RGBW pixel configuration including one unit pixel provided with four colors of red (R), green (G), blue (B) and white (W), and the white sub-pixel on the following light being offset from the white sub-pixel on the preceding row. The transmission of the MLD is improved by the additional light provided via the white sub-pixel, which are distributed across different portions of the panel.

FIG. 4C illustrates an RGBW pixel configuration including one unit pixel provided with four colors of red (R), green (G), blue (B) and white (W) provided in a quad unit. Each quad unit including a first pixel with sub-pixel R and sub-pixel G provided adjacent to each other and a second pixel provided below the first pixel with sub-pixel B and sub-pixel W provided adjacent to each other. The arrangement of the RGBW pixels is not limited to the embodiments shown in FIGS. 4A-4C, but may include other configurations of pixel units with two or more of the red (R), green (G), blue (B) and white (W) sub-pixels.

RGB is the most commonly used color model which is an additive color model. In these systems, the color equals the sum of the R, G, and B pixels. In RGBW, the output equals the sum of the R, G, B and W pixels. The output of the RGB pixels in an RGB model may be modified to compensate for the output of the W pixel region.

In traditional single layer RBGW displays, driving circuitry from the system on chip (SOC) and the LCD timing controller are provided to control the red (R), green (G), blue (B), and white (W) sub-pixels and the light sources. In some systems, a special circuit and computations need to be performed to converts input data of three colors (R, G, B) to input data of four colors (RGBW).

Exemplary embodiments of this application introduce the white (W) sub-pixels into the displays of the MLD without introducing the complexities provided by traditional display systems. For example, exemplary embodiments of this application control the RGB sub-pixels using standard methods (e.g., with a data driver and gate driver) but the white (W) sub-pixels are not provided with associated electronics (e.g., no transistors or electrode structures are provided to control the white (W) sub-pixel). Thus, while a voltage is used to control the alignment of the liquid crystal molecules in the red (R), green (G), blue (B) sub-pixels, the white (W) sub-pixel may include a fixed pre-aligned liquid crystal molecules.

The liquid crystal within the white (W) sub-pixel may be aligned (e.g., by rubbing or photoalignment methods) such that it would normally be black in the case of a standard single layer LCD with crossed polarizers. For example, the liquid crystal molecules in the white (W) sub-pixel may have a preset uniform orientation at 45 degrees with the electrodes (the LC director is uniform throughout the cell). If the white (W) sub-pixel is provided in a single layer display with cross polarizers, light from a light source would pass the back polarizer to provide polarized light to the white (W) sub-pixel, the polarized light would enter and exit the white (W) sub-pixel without a change in the polarization, and the polarized light exiting the white (W) sub-pixel will be blocked by the front polarizer.

In MLD system with a pair of crossed polarized layers, the light transmitted through the displays is not analyzed until it reaches the front polarizer. Accordingly, light from the rear polarizer transfers through the transparent regions of the display (e.g., rear LCD) without a color filter attenuation. The polarized rays, depending on the interaction with the subsequent liquid crystal orientations in the display (e.g., front LCD) can boost the brightness in the red (R), green (G), or blue (B) sub-pixels. For example, a red (R), green (G), or blue (B) sub-pixel may have a 10% boost in luminance.

Compared to a MLD including the standard RGB display, providing the (W) sub-pixel in a MLD allows for the (W) sub-pixel to transmit additional light within the MLD to improve the luminance of one or more of the displays of the MLD, and/or reduction in the power consumption (e.g., due to reduction in the backlight). Table 1 includes a summary of luminance improvements provided when one or more displays of an MLD include RGBW configurations according to embodiments of this disclosure.

TABLE 1

| Configuration | Effect |
|---|---|
| RGBW Front Display | Both layers have an effective |
| RGBW Rear Display | luminance increase |
| RGB Front Display | Large increase in front content |
| RGBW Rear Display | luminance and reduction in luminance |
| | of rear layer content |
| RGBW Front Display | Large increase in rear content |
| RGB Rear Display | luminance and reduction in luminance |
| | of front layer content |

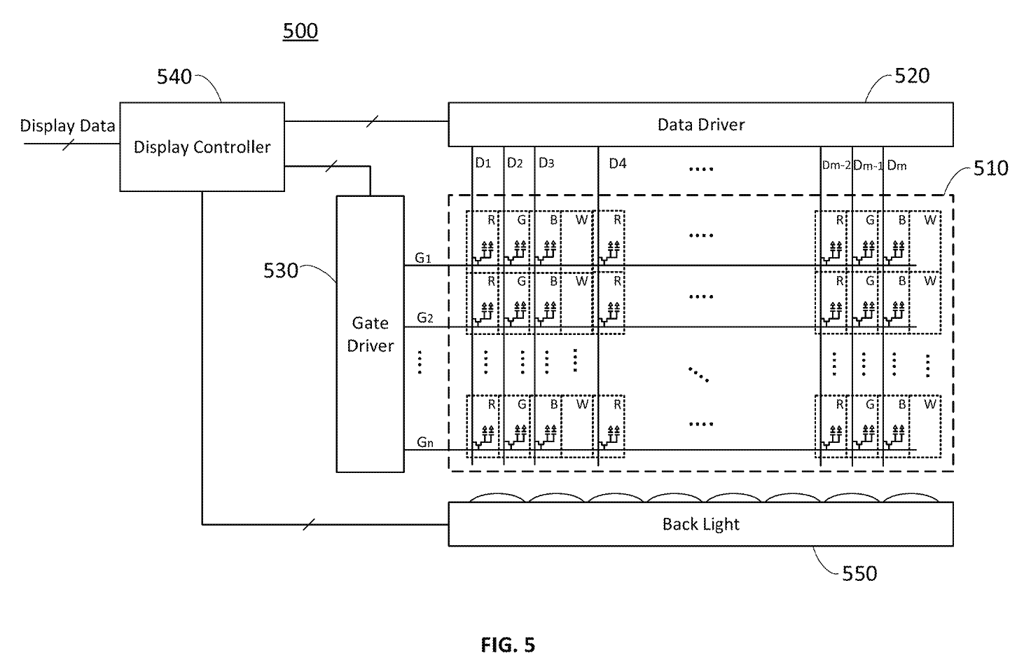

FIG. 5 illustrates an exemplary embodiment of control system 500 for a display including RGBW sub-pixel configuration. The exemplary system 500 may be provided for one or more of the displays in an MLD. While FIG. 5 illustrates a specific arrangement of RGBW sub-pixels, the arrangements are not so limited. Other arrangements, such as arrangements shown in FIGS. 4A-4C, may be provided in the system 500 of FIG. 5.

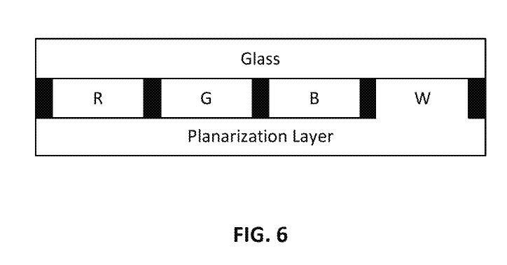

The system 500 includes a display panel 510 comprising sub pixels including active red (R), active green (G), active blue (B), and passive white (W) sub-pixels. The red (R), green (G), blue (B), and white (W) sub-pixels are arranged in a matrix configuration. The red (R), green (G), and blue (B) sub-pixels have corresponding color filters. The white (W) sub-pixel may have no color filter. As illustrated in FIG. 6, according to one embodiment, a filter layer including RGB color filter patterns may include an organic/planarization layer on one side of the color filter patterns. The planarization layer may include one or more layers (of same or different material) and may fill a gap of the filter layer corresponding to the white (W) sub-pixel of the display. The planarization layer may act as a white color filter pattern to display white color. The respective sub-pixels may have the same size ratio. The sub-pixels are illustrated having a repeating RGBW configuration but are not so limited.

As illustrated in FIG. 5, each of the active sub-pixels includes an associated transistor (e.g., a thin film transistor) coupled to respective data lines D1-Dm and gate lines G1-Gn. The passive white (W) sub-pixels include pre-aligned liquid crystal molecules and do not have transistors or electrode structures. The transistors may be formed in the respective regions of the active sub-pixels defined by n gate lines G1-Gn and m data lines D1-Dm. The liquid crystal cells of the active sub-pixels are connected with the respective transistors. The respective transistor is provided a data signal via one of the data lines (e.g., data line D1) in response to a scan pulse provided by the respective gate line (e.g., gate line G1). In FIG. 5, the liquid crystal cell of the sub-pixel is represented with an LCD capacitor corresponding to a common electrode and a sub-pixel electrode connected to the transistor. A storage capacitor is provided in the active sub-pixel configured to maintain the data signal charge on the LCD capacitor until the next data signal is received.

A data driver 520 is configured to supply video signals to RGB sub-pixels via the data lines D1-Dm. A gate driver 530 is configured to supply a scan pulse to RGB sub-pixels via the gate lines G1-Gn. A display controller 540 is configured to receive display data (e.g., from a Graphics Processing Unit) and control operation of the data driver 520 and gate driver 530. The display data may include input image signals R, G, and B and input control signals for controlling the display of the input image signals. The input control signals may include a vertical synchronizing signal VSYNC, a horizontal synchronizing signal HSYNC, a main clock MCLK, and/or a data enable signal DE. Based on the received display data, the display controller 540 may generate data control signals form the data driver and gate control signals for the gate driver, Based on the received display data, the display controller 540 may also control the operation of the back light 550. The display controller 540 may be configured to individually control a plurality of light sources provided in the back light 550.

As illustrated in FIG. 5, the processing circuitry for controlling the RGB sub-pixels of the RGBW display panel, according to the embodiments of this disclosure, do not require additional components over a traditional RGB display panel processing circuitry. Similarly, removing the transistors or electrode structures associated with the white (W) sub-pixels reduces the complexity of the traditional RGBW display panels while increasing the luminance of the MLD. Providing for the white (W) sub-pixels in the one or more display panels of the MLD improves the luminance of one or more of the displays of the MLD, and/or reduction in the power consumption.

A single display 510 is illustrated in FIG. 5. In some exemplary embodiments, the MLD may include a plurality of display panels arranged in a substantially parallel manner. Each of the display panels may include its own associated gate driver and data driver. In some embodiments, the display controller 540 may be configured to provide control signals to a plurality of gate driver and data drivers. Alternatively, a dedicated display controller may be provided for each of the display panels.

As discussed above, the plurality of display panels may be arranged in a substantially parallel manner, with a front display panels overlapping one or more rear display panels. In one embodiment, the white (W) sub-pixels in one of the display panels may be aligned with white (W) sub-pixels in one or more other overlapping display panels. In another embodiment, the white (W) sub-pixels in one of the display panels may be shifted from the white (W) sub-pixels in one or more other overlapping display panels.

In some embodiments, the white (W) sub-pixels may include transistors and/or data lines (not illustrated in FIG. 5) but may not be controlled by the control circuitry (e.g., data driver 520, gate driver 530, and display controller).

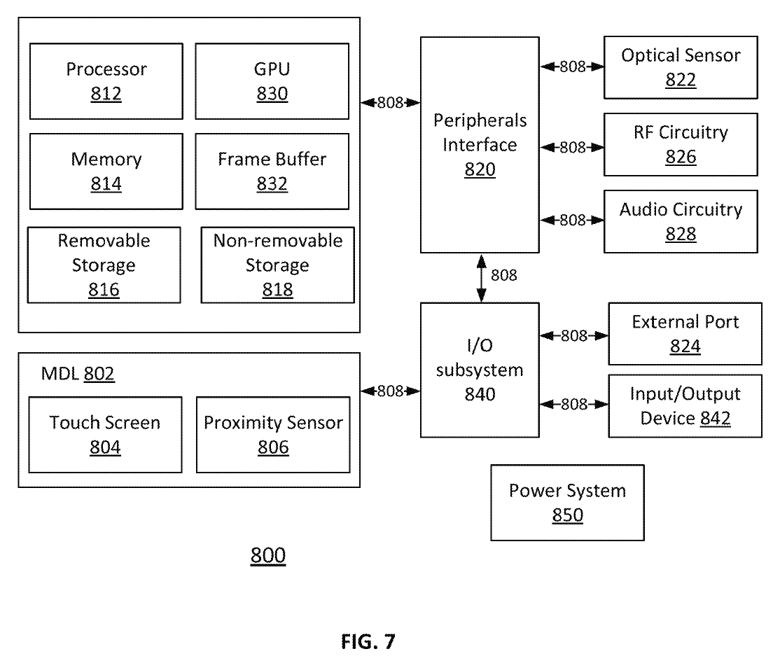

FIG. 7 illustrates an exemplary system 800 upon which embodiments of the present disclosure(s) may be implemented. The system 800 may be a portable electronic device that is commonly housed, but is not so limited. The system 800 may include a multi-layer display 802 including a plurality of overlapping displays. The multi-layer system may include a touch screen 804 and/or a proximity detector 806. The various components in the system 800 may be coupled to each other and/or to a processing system by one or more communication buses or signal lines 808.

The multi-layer display 802 may be coupled to a processing system including one or more processors 812 and memory 814. The processor 812 may comprise a central processing unit (CPU) or other type of processor. Depending on the configuration and/or type of computer system environment, the memory 814 may comprise volatile memory (e.g., RAM), non-volatile memory (e.g., ROM, flash memory, etc.), or some combination of the two. Additionally, memory 814 may be removable, non-removable, etc.

In other embodiments, the processing system may comprise additional storage (e.g., removable storage 816, non-removable storage 818, etc.). Removable storage 816 and/or non-removable storage 818 may comprise volatile memory, non-volatile memory, or any combination thereof. Additionally, removable storage 816 and/or non-removable storage 818 may comprise CD-ROM, digital versatile disks (DVD) or other optical storage, magnetic cassettes, magnetic tape, magnetic disk storage or other magnetic storage devices, or any other medium which can be used to store information for access by processing system.

As illustrated in FIG. 7, the processing system may communicate with other systems, components, or devices via peripherals interface 820. Peripherals interface 820 may communicate with an optical sensor 822, external port 824, RC circuitry 826, audio circuitry 828 and/or other devices. The optical sensor 882 may be a CMOS or CCD image sensor. The RC circuitry 826 may be coupled to an antenna and allow communication with other devices, computers and/or servers using wireless and/or wired networks. The system 800 may support a variety of communications protocols, including code division multiple access (CDMA), Global System for Mobile Communications (GSM), Enhanced Data GSM Environment (EDGE), Wi-Fi (such as IEEE 802.11a, IEEE 802.11b, IEEE 802.11g and/or IEEE 802.11n), BLUETOOTH (BLUETOOTH is a registered trademark of Bluetooth Sig, Inc.), Wi-MAX, a protocol for email, instant messaging, and/or a short message service (SMS), or any other suitable communication protocol, including communication protocols not yet developed as of the filing date of this document. In an exemplary embodiment, the system 800 may be, at least in part, a mobile phone (e.g., a cellular telephone) or a tablet.

A graphics processor 830 may perform graphics/image processing operations on data stored in a frame buffer 832 or another memory of the processing system. Data stored in frame buffer 832 may be accessed, processed, and/or modified by components (e.g., graphics processor 830, processor 812, etc.) of the processing system and/or components of other systems/devices. Additionally, the data may be accessed (e.g., by graphics processor 830) and displayed on an output device coupled to the processing system. Accordingly, memory 814, removable 816, non-removable storage 818, frame buffer 832, or a combination thereof, may comprise instructions that when executed on a processor (e.g., 812, 830, etc.) implement a method of processing data (e.g., stored in frame buffer 832) for improved display quality on a display.

The memory 814 may include one or more applications. Examples of applications that may be stored in memory 814 include, navigation applications, telephone applications, email applications, text messaging or instant messaging applications, memo pad applications, address books or contact lists, calendars, picture taking and management applications, and music playing and management applications. The applications may include a web browser for rendering pages written in the Hypertext Markup Language (HTML), Wireless Markup Language (WML), or other languages suitable for composing webpages or other online content. The applications may include a program for browsing files stored in memory.

The memory 814 may include a contact point module (or a set of instructions), a closest link module (or a set of instructions), and a link information module (or a set of instructions). The contact point module may determine the centroid or some other reference point in a contact area formed by contact on the touch screen. The closest link module may determine a link that satisfies one or more predefined criteria with respect to a point in a contact area as determined by the contact point module. The link information module may retrieve and display information associated with selected content.

Each of the above identified modules and applications may correspond to a set of instructions for performing one or more functions described above. These modules (i.e., sets of instructions) need not be implemented as separate software programs, procedures or modules. The various modules and sub-modules may be rearranged and/or combined. Memory 814 may include additional modules and/or sub-modules, or fewer modules and/or sub-modules. Memory 814, therefore, may include a subset or a superset of the above identified modules and/or sub-modules. Various functions of the system may be implemented in hardware and/or in software, including in one or more signal processing and/or application specific integrated circuits.

Memory 814 may store an operating system, such as Darwin, RTXC, LINUX, UNIX, OS X, WINDOWS, or an embedded operating system such as VxWorks. The operating system may include procedures (or sets of instructions) for handling basic system services and for performing hardware dependent tasks. Memory 814 may also store communication procedures (or sets of instructions) in a communication module. The communication procedures may be used for communicating with one or more additional devices, one or more computers and/or one or more servers. The memory 814 may include a display module (or a set of instructions), a contact/motion module (or a set of instructions) to determine one or more points of contact and/or their movement, and a graphics module (or a set of instructions). The graphics module may support widgets, that is, modules or applications with embedded graphics. The widgets may be implemented using JavaScript, HTML, Adobe Flash, or other suitable computer program languages and technologies.

An I/O subsystem 840 may include a touch screen controller, a proximity controller and/or other input/output controller(s). The touch-screen controller may be coupled to a touch-sensitive screen or touch sensitive display system. The touch screen and touch screen controller may detect contact and any movement or break thereof using any of a plurality of touch sensitivity technologies now known or later developed, including but not limited to capacitive, resistive, infrared, and surface acoustic wave technologies, as well as other proximity sensor arrays or other elements for determining one or more points of contact with the touch-sensitive screen. A touch-sensitive display in some embodiments of the display system may be analogous to the multi-touch sensitive screens.

The other input/output controller(s) may be coupled to other input/control devices 842, such as one or more buttons. In some alternative embodiments, input controller(s) may be coupled to any (or none) of the following: a keyboard, infrared port, USB port, and/or a pointer device such as a mouse. The one or more buttons (not shown) may include an up/down button for volume control of the speaker and/or the microphone. The one or more buttons (not shown) may include a push button. The user may be able to customize a functionality of one or more of the buttons. The touch screen may be used to implement virtual or soft buttons and/or one or more keyboards.

In some embodiments, the system 800 may include circuitry for supporting a location determining capability, such as that provided by the Global Positioning System (GPS). The system 800 may include a power system 850 for powering the various components. The power system 850 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices. The system 800 may also include one or more external ports 824 for connecting the system 800 to other devices.

Portions of the present invention may be comprised of computer-readable and computer-executable instructions that reside, for example, in a processing system and which may be used as a part of a general purpose computer network (not shown). It is appreciated that processing system is merely exemplary. As such, the embodiment in this application can operate within a number of different systems including, but not limited to, general-purpose computer systems, embedded computer systems, laptop computer systems, hand-held computer systems, portable computer systems, stand-alone computer systems, game consoles, gaming systems or machines (e.g., found in a casino or other gaming establishment), or online gaming systems.

1. An instrument panel comprising;
a multi-layer display including a front display panel and a rear display panel arranged in a substantially parallel manner, the front display panel overlapping the rear display panel, the front display panel and the rear display panel including an array of pixels, each pixel including active red (R), active green (G), and active blue (B) sub-pixels, the pixels in the front display panel and/or the rear display panel including a plurality of passive white (W) sub-pixels;
the multi-layer display further comprising a pair of crossed polarized layers, a first polarized layer of the pair of crossed polarized layers provided in front of and adjacent to the front display panel and a second polarized layer of the pair of crossed polarized layers provided behind and adjacent to the rear display panel;
a backlight configured to provide light to the front display panel and the rear display panel of the multi-layer display; and
a processing system comprising at least one processor and memory, the processing system configured to:
control the front display panel to display a first content; and
control the rear display panel to display a second content.

2. The instrument panel of claim 1, wherein the front display panel and the rear display panel are multi-domain in-plane-switching liquid crystal displays.

3. The instrument panel of claim 1, wherein the front display panel and the rear display panel are triple-domain in-plane-switching liquid crystal displays.

4. The instrument panel of claim 1, further comprises:
a first data driver configured to control the active red (R), active green (G), and active blue (B) sub-pixels of the front display panel and a first gate driver configured to provide scan pulses to the active red (R), active green (G), and active blue (B) sub-pixels of the front display panel;
a second data driver configured to control the active red (R), active green (G), and active blue (B) sub-pixels of the front display panel and a second gate driver configured to provide scan pulses to the active red (R), active green (G), and active blue (B) sub-pixels of the front display panel; and
a backlight controller configured to control the backlight based on the content simultaneously displayed on the front display panel and the rear display panel.

5. The instrument panel of claim 4, wherein the passive white (W) sub-pixels in the front display panel and/or the rear display panel are not coupled to the first and second data drivers and the first and second gate drivers.

6. The instrument panel of claim 4, wherein liquid crystal molecules in the passive white (W) sub-pixels are pre-aligned.

7. The instrument panel of claim 4, wherein liquid crystal molecules in the passive white (W) sub-pixels have a pre-set uniform orientation in a normal off state of the passive white (W) sub-pixels.

8. The instrument panel of claim 1, wherein the front display panel and the rear display panel each include a plurality passive white (W) sub-pixels.

9. The instrument panel of claim 1, wherein the passive white (W) sub-pixels are included only in the front display panel.

10. The instrument panel of claim 1, wherein the passive white (W) sub-pixels are included only the rear display panel.

11. The instrument panel of claim 1, wherein the first content is displayed such that at least a portion of the first content overlaps the second content displayed on the rear display panel, and at least a portion of the first content is displayed without overlapping the second content.

12. The instrument panel of claim 1, wherein relative luminance of the first content displayed on the front display panel is higher than relative luminance of the second content displayed on the rear display panel.

13. The instrument panel of claim 1, wherein the front display panel is a touch sensitive display, and the processing system is configured to detect whether a touch input is performed to a portion of the front display displaying the first content.

14. A multi-layer display system, comprising:
a first display and a second display arranged in a substantially parallel manner to the first display, the first display overlapping the second display, and the first display and the second display each including a plurality of red (R), green (G), and blue (B) multi-domain liquid crystal display cells, and the first display and/or the second display including a plurality of passive white (W) liquid crystal display cells;
a light source configured to provide light to the first display and the second display;
a first polarized layer provided in front of and adjacent to the first display;
a second polarized layer provided between the light source and the second display; and
a processing system comprising at least one processor and memory, the processing system configured to:
display a first content on the first display; and
display, on the second display, a second content.

15. The multi-layer display system of claim 14, wherein the red (R), green (G), and blue (B) multi-domain liquid crystal display cells are multi-domain in-plane-switching liquid crystal cells.

16. The multi-layer display system of claim 14, wherein the red (R), green (G), and blue (B) multi-domain liquid crystal display cells are triple-domain in-plane-switching liquid crystal cells.

17. The multi-layer display system of claim 14, wherein the first content is displayed such that at least a portion of the first content overlaps the second content displayed on the second display, and at least a portion of the first content is displayed without overlapping the second content.

18. The multi-layer display system of claim 14, wherein liquid crystal molecules in the passive white (W) liquid crystal display cells are pre-aligned.

19. The multi-layer display system of claim 14, wherein liquid crystal molecules in the passive white (W) liquid crystal display cells have a pre-set uniform orientation in a normal off state of the passive white (W) liquid crystal display cells.

20. The multi-layer display system of claim 14, wherein the first display and the second display each include a plurality passive white (W) liquid crystal display cells.

21. The multi-layer display system of claim 14, wherein only the second display includes the plurality passive white (W) liquid crystal display cells.

22. An instrument panel comprising;
a multi-layer display including a plurality of display panels arranged in a substantially parallel manner, the plurality of display panels including a rear display panel and a front display panel overlapping the rear display panel, at least one of the display panels including active red (R) sub-pixels, active green (G) sub-pixels, active blue (B) sub-pixels, and passive white (W) sub-pixels;
the multi-layer display further comprising a pair of crossed polarized layers, a first polarized layer of the pair of crossed polarized layers provided in front of and adjacent to the front display panel and a second polarized layer of the pair of crossed polarized layers provided behind and adjacent to the rear display panel;
a backlight configured to provide light to the front display panel and the rear display panel of the multi-layer display; and
a processing system comprising at least one processor and memory, the processing system configured to simultaneously display content on the plurality of display panels.

23. The instrument panel of claim 22, wherein at least one of the plurality of display panels is a monochrome panel.

24. The instrument panel of claim 22, wherein the front display panel and the rear display panel are multi-domain in-plane-switching liquid crystal displays.

25. The instrument panel of claim 22, wherein the active red (R) sub-pixels, the active green (G) sub-pixels, the active blue (B) sub-pixels include associated transistors coupled view data lines and the passive white (W) sub-pixels do not include associated transistors.

26. The instrument panel of claim 22, further comprising a pair of crossed polarizers, wherein the plurality of display panels are disposed between the pair of crossed polarizers, and liquid crystal molecules in the passive white (W) sub-pixels are pre-aligned such that during operation regions of the multi-layer display corresponding to the passive white (W) sub-pixels are black.
